(19) United States
(12) Patent Application Publication
(10) Pub. No.: US 2008/0241331 A1
(43) Pub. Date: Oct. 2, 2008

(54) Foods Comprising Healthy Combinations of Tofu and Flour, or Tofu and Meat and Methods of Producing the Same

(76) Inventors: Michael A. Lovett, Topanga, CA (US); Linda G. Berger, Topanga, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/693,521

(22) Filed: Mar. 29, 2007

(51) Int. Cl. A21D 13/08; A23L 1/325

(52) U.S. Cl. 426/556; 426/643

(57) ABSTRACT

Specific and unique proportions of ingredients, including tofu, are used to make inventive foods in which tofu replaces a significant percentage of ingredients of animal origin. Among the inventive foods incorporating tofu in a simple process are dough balls designed to form fresh pasta or pizza, batters designed to form waffle products, and ground meat and ground seafood products comprising sausage, hamburgers, and meat loaf. The products are easy to make and high in nutritional value as substitute soy protein for animal fat in each case, thereby reducing the caloric and fat content significantly compared with conventional products of these types.

### FIELD OF INVENTION

The present invention relates generally to creation of foods designed to be more beneficial to health than their conventional counterparts, including pasta, pizza dough, waffles, sausages and other ground meat products by using novel combinations of tofu with flour or meat and methods of producing the same. These foods have markedly fewer calories and carbohydrates than conventional flour based food products, and markedly fewer calories, and far less cholesterol and other fats than conventional ground meat based food products, but retain authentic appearance and taste.

### BACKGROUND OF THE INVENTION

Popular foods like pasta, both dried and fresh, pizza dough, and waffles have a high caloric and carbohydrate content per unit weight because their relative content of flour is high. In addition, fresh pasta and waffles usually contain the cholesterol contributed by egg yolks.

There is a need for low calorie, low carbohydrate, natural tasting alternatives to pasta, pizza dough, and waffles.

In addition, ground meat products with wide appeal like sausages and hamburgers are highly caloric, as well as tasty, due to their animal fat content. Alternatives to meat in the marketplace do not contain meat. The well established health risks posed by obesity and dietary fats have led growing numbers of health conscious meat eaters to purchase vegetarian meat and dairy alternatives, despite the facts that these products have chemically processed ingredients, and lack the authentic flavor of meat. For example, vegetarian sausages contain textured vegetable protein, soy protein, isolate, sugar, cellulose gum, modified potato starch, hydrolyzed vegetable protein, artificial coloring, guar gum, artificial flavors and xanthan gum. While packages are labeled “vegetarian”, they are accurately not labeled “natural” or “organic.” The taste of most of these products could not be mistaken for that of authentic meat or dairy products. Nonetheless, the commercial success of meatless soy protein based vegetable sausages, hamburgers, dressings, and cheese substitutes provides evidence that growing numbers of meat eaters are highly motivated to reduce fat and calories, and will eat soy based foods to do so.

There is a need for ground meat products with lower calories, fats, and cholesterol that contain natural ingredients and retain natural taste, in contrast to the artificial taste and man-made chemical ingredients of soy protein based or other meat and diary alternatives.

### SUMMARY OF THE PREFERRED EMBODIMENTS

Food products disclosed herein are prepared from inventive combinations of tofu and flour and tofu and meat that preferably do not require other ingredients to bind the constituents of the resulting food products. These inventive foods have markedly fewer calories and carbohydrates than conventional flour based food products and far less cholesterol and other fats than conventional ground meat based food products, but retain authentic appearance and taste.

This invention preferably results in cholesterol free fresh pasta, pizza, and waffles with authentic taste and texture but with significantly fewer calories, and less fat. Combinations of tofu with flour are used to create novel inventive forms of flour-based foods including pasta, pizza dough, and waffles. Inventive pasta and pizzas have 30% to 50% fewer calories and carbohydrates than traditional pasta and pizza. Inventive fresh pastas are also cholesterol free, unlike fresh pasta made with eggs. The raw egg content of traditional fresh pasta undoubtedly contributes to its highly perishable nature. Egg-free pasta is much less perishable than traditional fresh pasta made with eggs. Inventive fresh pasta can be made using a variety of wheat flours, including all purpose flour, semolina, 100% whole-wheat flour, or varied combinations of wheat flours including but not limited to whole wheat, semolina, all purpose flour, rye flour with tofu. Fresh whole-wheat pasta is rarely seen in the marketplace, and contains a mixture of all purpose flour and whole-wheat flour, as well as eggs. Therefore, the ability to make fresh pasta with 100% whole-wheat flour and no eggs constitutes a unique product. The pasta of the invention can also be dried. Inventive waffles contain less than ⅓ the calories and less than ¼ the carbohydrates of ordinary waffles. These waffles are cholesterol free.

Combinations of tofu with ground meat or fish are used to create novel sausages and hamburgers. These sausages may contain less than ⅓ of the calories and less than ⅕ of the fat of traditional pork sausage and may have 35%-50% fewer calories than vegetarian sausage products made with soy-based meat substitutes, but nonetheless have the appearance and taste of real meat. In simplest concept, ground tofu has been substituted for ground animal fat in the creation of the inventive sausages. Nothing artificial is used in making these inventive foods. Tofu is generally not discernable as an ingredient in inventive pasta, pizza, or ground meats.

Disclosed herein are tofu and flour products and methods of preparing such products.

In one preferred embodiment, firm tofu, per 14 ounces, may comprise from about 28 g to about 43 g protein, from about 7 g to about 11 g carbohydrates, and from about 252 calories to about 378 calories. Preferably, firm tofu, per 14 ounces, may comprise from about 33 g to about 40 g protein, from about 8 g to about 10 g carbohydrates, and from about 283 calories to about 347 calories. More preferably, firm tofu, per 14 ounces, may comprise 36 g protein, 9 g carbohydrates, and 315 calories. Firm tofu, however, is not limited by the foregoing compositions.

In one preferred embodiment, the dough ball comprises from greater than about 35% to less than about 65% by weight firm tofu, and from greater than about 30% to less than about 65% by weight flour. In one aspect of this preferred embodiment, the dough ball may comprise from greater than about 40% to less than about 62% by weight firm tofu, and greater than about 35% to less than about 60% by weight flour. More preferably, the dough ball can comprise greater than about 40% to less than about 48% by weight tofu, and greater than about 50% to less than about 60% by weight flour. In a highly preferred embodiment, a food product is made from the dough ball. In one aspect of this highly preferred embodiment, the food product is pasta. In addition, the dough ball may comprise 0.0% to about 10% water by weight and about 0.01 to about 5.0% seasoning agents/salt by weight.

In accordance with this aspect of the preferred embodiment, the dough ball may not comprise shortening. In yet another aspect of the preferred embodiment, the dough ball may not comprise milk products, egg products, or potato products. In other preferred embodiments the product may contain salt, fresh or dried herbs, spinach, saffron, or other ingredients to provide flavor and color.

In one embodiment, one pound of fresh pasta dough of the invention has about 692 calories to about 1,038 calories, about 31 g to about 49 g protein, and about 132 g to about 200 g carbohydrates. In one aspect of this preferred embodiment, one pound of fresh pasta dough of the invention has about 778 calories to about 952 calories, about 36 g to about 44 g protein, and about 149 g to about 183 g carbohydrates. Preferably, one pound of fresh pasta dough of the invention has about 821 calories to about 908 calories, about 38 g to about 42 g protein, and about 158 g to about 174 g carbohydrates. More preferably, one pound of pasta dough contains 865 calories, 39.9 g protein, and 166 g carbohydrates. Fresh pasta made in this embodiment doubles in weight upon cooking, so it is a particularly low calorie food, containing only about 432 calories per pound of cooked product. By contrast, commercially prepared dried pasta contains 1600 calories and 328 g carbohydrates per pound, and will contain cholesterol if the product is made with eggs. Fresh pasta available in supermarkets is made with eggs and contains 1280 to 1700 calories per pound. For example, one pound of Buitoni Fresh Pasta has 1312 calories, 273 mg cholesterol, 246 g carbs, and 54.7 g protein. Homemade fresh pasta recipes are mixtures of flour and whole eggs. One pound fresh pasta made with Mario Batali's recipe (www.foodtv.com) has 1254 cal, 576 mg cholesterol, 205 g carbs and 50 g protein. The nutritional benefits of the highly preferred embodiment of the inventive pasta made with all purpose flour compared to traditional dried and fresh pasta are obvious. Fresh whole wheat pasta is not commercially available, and inventive pasta made with 100% whole wheat has nutritional benefits derived from its content of 100% whole grain as well as those derived from the soy protein in the tofu.

In one preferred embodiment of the invention, the dough ball may comprise from about greater than 30% to about less than 66% by weight firm tofu, and from about greater than 30% to about less than 61% by weight flour. In one aspect of this preferred embodiment, the dough ball may comprise greater than about 35% to less than about 61% by weight firm tofu and greater than about 35% to less than about 54% by weight flour. Preferably, the dough ball may comprise from greater than about 49% to less than about 61% firm tofu, and from greater than about 37% to less than about 47% by weight flour. In one aspect of this embodiment, the dough ball comprises of from about 0.01% to about 3.0% by weight sweetening agent. In a highly preferred embodiment, the dough ball may comprise yeast as a leavening agent. Other leavening agents may be used without departing from the scope of the invention. In certain embodiments, the dough ball may be used to make a food product. Typically, the dough ball may be used to make pizza dough.

In one preferred embodiment of the invention, the dough ball may comprise from about greater than 30% to about less than 66% by weight firm tofu and from about greater than 30% to about less than 61% by weight flour. The flour may comprise from greater than 0% to about 50% by weight masa harina and from about 50% to about 100% by weight bread flour or other wheat flour. In one aspect of this preferred embodiment, the dough ball may comprise greater than about 35% to less than about 61% by weight firm tofu and greater than about 35% to less than about 54% by weight flour. The flour may comprise from greater than 0% to about 50% by weight masa harina and from about 50% to about 100% by weight bread flour or other wheat flour. Preferably, the dough ball may comprise from greater than about 49% to less than about 61% firm tofu and from greater than about 37% to less than about 47% by weight flour. The flour may comprise from greater than 0% to about 50% by weight masa harina and from about 50% to about 100% by weight bread flour or other wheat flour. In a highly preferred embodiment, the dough ball comprises about 57% by weight firm tofu and about 43% by weight flour. The about 43% by weight flour may comprise about 67% by weight bread flour and about 33% by weight masa harina. In one aspect of this embodiment, the dough ball comprises of from about 0.01% to about 3.0% by weight sweetening agent. In a highly preferred embodiment, the dough ball may comprise yeast as a leavening agent. Other leavening agents may be used without departing from the scope of the invention. In certain embodiments, the dough ball may be used to make a food product. Typically, the dough ball may be used to make pizza dough or tortilla chips. The pizza dough ball may be rolled very thin as for lasagna, making tortilla chips. Masa harina provides the corn flavor for the tortilla chips.

In accordance with this aspect of the preferred embodiment, the dough ball may not comprise shortening, although extra virgin olive oil may be added for flavor. In yet another aspect of the preferred embodiment, the dough ball may not comprise milk products, egg products, or potato products. In other preferred embodiments the product may contain salt, fresh or dried herbs, such as dried red chile flakes, or other ingredients to provide flavor and color.

In a preferred embodiment, the pizza dough may comprise from about 600 calories to about 900 calories, from about 33 g to about 49 g protein, and from about 123 g to about 185 g carbohydrates. In one aspect of the invention, the pizza dough may comprise from about 674 calories to about 823 calories, from about 37 g to about 45 g protein, and from about 139 g to about 169 g carbohydrates. More preferably, the pizza dough may comprise from about 712 calories to about 786 calories, from about 39 g to about 43 g protein, and from about 146 g to about 162 g carbohydrates. For example, the pizza dough may contains approximately 749 calories, 40.8 g protein and 154 g carbohydrates per pound, and no cholesterol or added fat. This inventive pizza dough contains approximately 30% fewer calories and carbohydrates than conventional pizza dough, which typically contains added oil.

In yet another preferred embodiment of the invention, a batter may comprise greater than about 35% to less than about 65% by weight firm tofu, and greater than about 5% to less than about 25% by weight wheat flour, which may be all purpose flour, bread flour, or 100% whole wheat flour, or any combination of whole wheat, bread flour, and/or all purpose flour. In one aspect of this preferred embodiment, the batter may comprise greater than about 40% to less than about 60% by weight firm tofu, greater than about 6% to less than about 18% by weight wheat flour, which may be all purpose flour, bread flour, or 100% whole wheat flour, or any combination of whole wheat, bread flour, and/or all purpose flour. In a highly preferred embodiment of the invention, the batter may comprise greater than about 43% to less than about 57% by weight firm tofu, and greater than about 8% to less than about 13% by weight wheat flour, which may be all purpose flour, bread flour, or 100% whole wheat flour, or any combination of whole wheat, bread flour, and/or all purpose flour. Additionally the batter comprises 0-10% by weight cholesterol free liquid egg substitute, or an equivalent amount of egg whites, and 0%-40% by weight, more preferably, 20% to 40% by weight water or milk. In a typical embodiment, baking soda is added to 0.25% to 1% on a wgt./wgt. basis as a leavening agent. Liquid vanilla extract and/or other flavoring agents including salt are added to the batter to taste. Typically, the batter is used to make waffles, pancakes, and the like.

The waffle batter may comprise from about 252 calories to about 378 calories, from about 26 g to about 36 g carbohydrates, and less than 250 mg cholesterol per about 16 ounces. Preferably, the waffle batter may comprise from about 284 calories to about 347 calories, from about 27 g to about 33 g carbohydrates, and less than 100 mg cholesterol per about 16 ounces. More preferably, the waffle batter may comprise from about 300 calories to about 331 calories, from about 29 g to about 32 g carbohydrates, and less than about 50 mg cholesterol per about 16 ounces. For example, the waffle batter may contains 315 calories, 30 g carbohydrates, and 0 mg cholesterol per 16 ounces. In contrast, Emeril Lagasse's recipe (www.foodtv.com) for Classic Belgian Waffles contains 976 calories 123 g carbohydrates, and 456 mg cholesterol per 16 ounces. Inventive waffles contain less than ⅓ the calories and less than ¼ the carbohydrates of Emeril's Classic Belgian Waffles.

In another preferred embodiment, the invention comprises an inventive meat or seafood product comprising meat or seafood and tofu. In one aspect of the preferred embodiment, the inventive meat and fish product comprises at least about 20% tofu by weight. In a highly preferred embodiment, the inventive meat and fish product comprises about 33% tofu by weight. A higher percentage tofu, up to 65% or more may be utilized based upon taste and binding of the ingredients. In essence, the invention substitutes ground tofu for animal fat in the form of pork fat back (for sausage) or cream (for seafood sausage). The tofu both binds the meat and reduces the caloric and fat content of the product compared to conventional meat or seafood based sausage. In a preferred embodiment, the invention may be embodied in hamburgers, meat sausages, and seafood sausages. Meat sausages made with tofu in this invention may comprise individual meats such as, but not limited to pork, beef, lamb, chicken, duck, and guinea fowl. Sea food sausage made with tofu in accordance with this invention may comprise individual fish, shellfish, or any combination thereof. Additional ingredients may be added to other preferred embodiments, such as vegetables like roasted peppers, onions, chiles, etc. The seasonings that may be added to preferred embodiments are unlimited.

In another preferred embodiment, methods for preparing these foods products are provided. One method comprises grinding firm tofu in a meat grinder, and binding the ground tofu with ground meat or ground seafood in an electric mixer. In one aspect of the preferred embodiment, said binding is accomplished by use of a mixer. In another aspect of the preferred embodiment, said binding is accomplished by mixing by hand.

In another preferred embodiment, a method of making a dough product comprises providing firm tofu, draining the tofu, weighing the tofu, mashing the tofu, and adding flour, wherein the dough product comprises of greater than about 49% to less than about 55% by weight tofu, and greater than about 45% to less than about 60% by weight flour. The firm tofu may be mashed in a variety of ways including by hand, with a simple device such as a potato masher, or by stirring in a electric mixer or the like. In certain embodiments, the dough product is used to make pasta and the like. In a highly preferred embodiment, the method of making a dough product is used to prepare pasta.

In yet another embodiment, a method of making a dough product comprises providing firm tofu, draining the tofu, weighing the tofu, mashing the tofu, and adding flour and yeast. In a highly preferred embodiment of the invention, the dough ball comprises from greater than about 49% to less than about 61% by weight firm tofu and greater than about 37% to less than about 47% by weight flour. In a highly preferred embodiment, yeast is included in the method of making a dough product used to prepare pizza dough.

In a preferred embodiment, a method of making a dough product comprises providing firm tofu, draining the tofu, weighing the tofu, mashing the tofu, and adding flour and yeast. In a highly preferred embodiment of the invention, the dough ball comprises from greater than about 49% to less than about 61% by weight firm tofu and greater than about 37% to less than about 47% by weight flour. The flour may comprise greater than 0% to about 50% by weight masa harina and about 50% to about 100% by weight flour. In a highly preferred embodiment, the dough product may be rolled thin to make tortilla chips.

In another preferred embodiment, a method of making a waffle product comprises providing firm tofu, draining the tofu, weighing the tofu, adding flour, adding water, adding egg substitute or egg white, and flavorings and using a blender to mix, wherein the waffle product comprises about greater than about 43% to less than about 57% by weight firm tofu, and 8% to 15% by weight wheat flour.

Other objects, features, and advantages of the present invention will become apparent to those skilled in the art from the following detailed description. It is to be understood, however, that the detailed description and specific examples, while indicating the preferred embodiments of the present invention, are given by way of illustration and not limitation. Many changes and modifications within the scope of the present invention may be made without departing from the spirit thereof, and the invention includes all such modifications. Such modifications are also intended to fall within the scope of the appended claims.

### DETAILED DESCRIPTION OF THE PREFERRED EMBODIMENTS

“Meat” as used herein may comprise meat such as for example sausages and hamburgers prepared from chicken, lamb, pork, and the like. Meat may also refer to fish chicken, lamb, pork, or any other meat. “Fish” as used herein may also comprise fish and shellfish.

“Meat grinder” as used herein may comprise a blender, food processor, hand-held-blender, hand-held grinder, or the like.

“Flour” as used herein may comprise all wheat flours including all purpose flour, whole wheat flour, bread flour, rye flour, or the like.

“Batter” as used herein may be a “waffle batter.”

### EXAMPLE 1

### Dough Ball Compositions

The dough ball disclosed herein may be made into classical or novel pasta shapes, including, but not limited to, fettuccine, linguine, lasagna, ravioli, and the like.

### Example 1

### Dough Ball #1 for Pasta

Dough Ball #1 for Pasta

| Ingredients | % by weight |
|---|---|
| Firm tofu | 40–48 |
| Flour | 50–60 |
| Water | 0.01–10 |
| Seasoning agents/Salt | 0.01–3.5 |

Optionally, the embodiment comprises colorings for example, but not limited to, saffron threads, beet juice, squid ink, or cooked and drained spinach. Optionally, the embodiment comprises flavoring agents. Typically, the embodiment may comprise finely chopped fresh or dried herbs, such as, but not limited to, rosemary, oregano, thyme, chives, chile powder, turmeric, ginger, raz el hanout, garlic, sage, and herbs de Provence. Additional or alternative flavoring agents may be in the form of flavored oil, such as, but not limited to, white or black truffle oil, sesame chili oil, or the like. Salt may be Kosher salt, sea salt, iodized salt or the like.

The dough ball and resultant pasta or the like of the invention has various nutritional advantages. The standard two pound recipe for example may contain 1415 calories, 43.7 g protein, 323 g carbohydrates, and 43.7 g protein from the flour, and 315 calories, 36 g protein, and 9 g carbohydrates from the tofu. For example, two pounds of the inventive pasta dough therefore may contain 1730 calories, 79.7 g protein, and 332 g carbohydrates. Per pound this is 865 calories, 39.9 g protein, and 166 g carbohydrates. However, the calories, protein content, and carbohydrate content will vary depending on the percentages of the ingredients added. The pasta of the invention doubles in weight upon cooking, so it is a particularly low calorie food, containing only about 432 calories per pound of cooked product. The pasta of the instant invention may contain more or fewer calories depending on the exact proportions of ingredients added.

On the other hand, commercially prepared dried pasta typically contains 1600 calories and 328 carbohydrates per pound, and will contain cholesterol if the product is made with eggs. Fresh pasta available in supermarkets is made with eggs and contains 1280 to 1700 calories per pound. For example, one pound of Buitoni has 1312 calories, 273 mg cholesterol, 246 g carbs, and 54.7 g protein. Homemade fresh pasta recipes are mixtures of flour and whole eggs. One pound fresh pasta made with Mario Batali's recipe (www.foodtv.com) has 1254 cal, 576 mg cholesterol, 205 g carbohydrates, and 50 g protein. The nutritional benefits of inventive pasta made with all purpose flour or whole wheat flour compared to traditional dried and fresh pasta are great. Fresh whole wheat pasta is rarely available commercially; when available, whole wheat flour is usually mixed with all purpose or other flours. This invention can utilize 100% whole wheat flour, and its associated nutritional benefits, along with those of soy protein in the form of tofu. Unlike virtually all fresh pastas in the marketplace, this invention does not include eggs or egg products, and is cholesterol free.

In this section we will compare inventive pasta to published prior art. One issued U.S. Patent and one published U.S. Patent application involve combining tofu with flour to form noodles. U.S. Pat. No. 6,641,855 for “Noodles Containing Tofu Puree”, issued in 2003, describes a homogenizing apparatus designed to produce a tofu suspension (puree) with micron size particles. Particles of this size are claimed to be the essential form of tofu needed to make tasty noodles. Coagulated soy milk is homogenized to a certain viscosity in suspension with soy milk. The method does not specify the ratio of bean curd derived weight relative to soy milk derived weight. Thus, the nutritional composition of this invention cannot be estimated, but it cannot be as great as that of solid bean curd (which is used in our procedure). Our invention differs procedurally in a most significant way: homogenization of the bean curd is not needed or employed by our procedure. Rather, we mix bulk tofu with wheat flour. No complex apparatus is needed for the mixing; only an electric mixer is needed. Our invention has none of the claimed properties of U.S. Pat. No. 6,641,855 in terms of particle size or viscosity. Inventive pasta is made with blocks of commercially available tofu that are directly mixed with flour to form pasta in an electric mixer as described above. The “Noodles Containing Tofu Puree” of U.S. Pat. No. 6,641,855 maintains that it is necessary to create micron sized tofu particles with a complex homogenizing device described in the patent to create good tasting pasta according to their tasting panel. In contrast, our invention consists simply of adding formed tofu blocks to flour in a specific ratio and mixing with an electric mixer or even by hand. Obviously a block of tofu has vastly different physico-chemical properties that those measured for the tofu puree.

The inventive pasta described herein also differs compositionally from U.S. Pat. No. 6,641,855. The homogenization procedure described in U.S. Pat. No. 6,641,855 results in a percentage of soy protein relative to wheat protein that is less than in the inventive pasta described herein. Inventive pasta contains a greater percentage of bean curd derived protein relative to wheat flour, and therefore has greater nutritional benefit. Since U.S. Pat. No. 6,641,855 did not specify the ratio bean curd to soymilk used in homogenization, the actual weight of bean curd protein U.S. Pat. No. 6,641,855 is not known. Briefly, their homogenization process of bean curd in soymilk must result in dilution of soy protein, rendering the product less nutritious than tofu block derived soy protein. Because pasta can be formed with only water and flour, the invention described in U.S. Pat. No. 6,641,855 may add little nutritive benefit in terms of caloric reduction. The procedure described herein for inventive pasta procedure is far simpler, and results in a nutritionally superior product with more soy protein relative to wheat flour. It is procedurally distinct from the process described in U.S. Pat. No. 6,641,855, and it is compositionally distinct for the reasons just described. The tofu puree based noodle described in U.S. Pat. No. 6,641,855 may also contain egg products, while our hybrid pasta is free of animal products.

One U.S. Patent application published in 2004, US Pub. No. 2004/0146629, involves combining tofu with flour to make pasta. This invention contains the following ingredients described as essential, egg white, mashed potato with milk and butter or margarine, baking soda, and dehydrated tofu. By contrast, baking powder, egg white, mashed, or any form of potato, milk, butter and margarine are not used in the inventive pasta described herein. Dehydrated tofu is not used in the inventive pasta described herein. Natural tofu is used in our invention, and is precisely weighed, since it gains water during storage.

### EXAMPLE 2

### Dough Ball #2 for Pizza

The dough ball disclosed herein may be made into, but not limited to, pizza and the like. The dough ball disclosed herein may also be made into any other food product also.

Dough Ball #2 for Pizza

| Ingredients | % by weight |
|---|---|
| Tofu | 49–61 |
| Flour | 37–47 |
| Water | 0.01–8.5 |
| Sweetener | 0.01–2.0 |
| Yeast | 0.1–2.0 |
| Seasoning agents/Salt | 0.01–5 |

In a highly preferred embodiment of the invention, the dough ball comprises from greater than about 49% to less than about 61% by weight firm tofu and from greater than about 37% to less than about 47% by weight flour, 1.6% sucralose, 1.6% yeast, and 1% salt.

In one aspect of the embodiment, the dough ball comprises from about 0.1% to about 2.0% sweetening agent. The sweetening agent may comprise sweeteners such as, but not limited to, artificial sweeteners such as sucralose, saccharine or aspartame, sugars such as sucrose, glucose, or fructose, or fruit juices which may be fresh, frozen or concentrated, dehydrated fruit or fruit juices, honey, molasses, barley malt, or any liquid sweetener and/or liquid syrup. The sweetener may be one suitable for diabetics.

In certain embodiments, the dough ball comprises from about 0.1% to about 2.0% by weight leavening agent. Typically, the leavening agent may be yeast, baking powder, or the like.

Optionally, the embodiment comprises flavoring agents. Typically, the embodiment may comprise finely chopped fresh or dried herbs, such as, but not limited to, rosemary, oregano, thyme, chives, chile powder, turmeric, ginger, raz el hanout, garlic, sage, and herbs de Provence. Additional or alternative flavoring agents may be in the form of flavored oil, such as, but not limited to, white or black truffle oil, sesame chili oil, or the like. Salt may be Kosher salt, sea salt, iodized salt or the like.

### EXAMPLE 3

### Waffle Batter Composition

The batter or waffle product disclosed herein may be made into, but not limited to, waffles, pancakes, and the like.

Waffle Batter

| Ingredients | % by weight |
|---|---|
| Tofu | 43–57 |
| Flour | 8–15 |
| Egg Substitute or egg white | 6–8 |
| Kosher Salt | 0.01–2 |
| Baking Powder | 0.02–1.6 |
| Vanilla Extract | 0.01–3.2 |
| Water or milk | 20–40 |

In a preferred embodiment comprised of tofu and flour, a batter is comprised of from greater than about 43% to less than about 57% firm tofu, and about 8-15% wheat flour, which may be all purpose flour, bread flour, or 100% whole wheat flour, or any combination of whole wheat, bread flour, and/or all purpose flour. Additionally the batter comprises 0-10% cholesterol free liquid egg substitute, or an equivalent amount of egg whites, and 0-40% water or milk. In a typical embodiment, baking powder is added to 0.25% to 1.6% on a wgt./wgt. basis as a leavening agent. More or less baking soda, or any other leavening agent, may be added. Liquid vanilla extract and/or other flavoring agents including salt are added to the batter to taste. Typically, the batter is used to make waffles, pancakes, and the like.

In one preferred embodiment, the waffle product comprises from about 35% to about 65%, typically from about 40% to about 60%, preferably from about 43% to about 57%, and more preferably about 45% by weight tofu; from about 5% to about 25%, typically from about 6% to about 18%, preferably from about 8% to about 13%, by weight flour.

In one aspect of the embodiment, the waffle product comprises from about 30% to about 40%, preferably from about 30% to about 35%, and more preferably about 30% by weight water. More or less water may be added as desired without departing from the scope of the invention. Certain embodiments may contain from about 0.01% to about 15%, preferably from about 3.0% to about 10.0%, and more preferably from about 6.5% egg substitute. Typically, the egg substitute does not contain cholesterol. The egg substitute may comprise egg beaters, egg whites, or any recipe for preparing egg substitutes known in the art. Eggs may be substituted for egg whites in whole or part if desired.

In one embodiment, per 16 ounces, the waffle batter may contain from greater than about 252 calories to less than about 378 calories, greater than about 24 g to less than about 36 g carbohydrates, and less than 500 mg of cholesterol. In one aspect of this embodiment, per 16 ounces, the waffle batter may contain from about 284 calories to about 347 calories, from about 27 g to about 33 g carbohydrates, and less than about 250 mg cholesterol. Preferably, per 16 ounces, the waffle batter may contain from about 300 calories to about 331 calories, 29 g to about 32 g carbohydrates, and less than about 100 mg cholesterol. Per 16 fluid ounces, a highly preferred embodiment of the inventive waffle batter may contain 315 calories, 30 g carbohydrates, and 0 mg cholesterol per 16 ounces. By contrast Emeril Lagasse's recipe (www.foodtv.com) for Classic Belgian Waffles contains 976 calories, 123 g carbohydrates, and 456 mg cholesterol per 16 fluid ounces. These cholesterol free inventive waffles therefore may contain less than ⅓ calories and less than ¼ the carbohydrates of Emeril's Classic Belgian Waffles.

### EXAMPLE 4

### Ground Meat and Ground Seafood Products

The meat and seafood products disclosed herein may be, for example, but not limited to, sausages, hamburgers, seafoods such as fish or shellfish, and any other meat or seafood or the like.

Ground Meat and Ground Seafood Products

| Ingredients | % by weight |
|---|---|
| Tofu | 33 |
| Meat or fish | 50–67 |
| Water, Seasoning/Flavoring agents | 0.01–45 |

In one preferred embodiment, the ground meat and ground fish product comprises at least 20% by weight tofu, preferably from about 30% to about 50% and more preferably about 33% by weight tofu. Typically, the ground meat and seafoood product does not require added animal fat, eggs, cream, or added protein extracts to achieve binding of the ingredients, or to achieve a juicy texture and natural taste. Typically, the percentage of meat or seafood in the meat product may vary anywhere from about 50% to about 80% by weight. Other percentages of meat by weight may also be used. Additionally, flavoring agents, seasoning agents, and other ingredients may be added alone or in combination.

### EXAMPLE 5

### Methods of Preparing Dough Balls

The dough ball compositions disclosed herein may be made according to the following methods.

In one preferred embodiment, the methods disclosed herein are used in connection with preparing a dough ball for use for example in the preparation of inventive pasta. The following discussion pertains to making 32 ounces of pasta dough. More or less dough may be made using the following proportions of ingredients.

In this embodiment, the tofu is prepared by using a “14 ounce” package of firm tofu. This is the typical package size found in grocery stores. Such 14-ounce containers of firm tofu typically contain 36 g protein, 9 g carbohydrates, and 315 calories. Any other size package of tofu may be used, however, as long as the tofu is weighed. This pertains to all food products disclosed herein. The “14 ounce” package of firm tofu is drained. After draining, the weight of tofu is taken. The drained weight may be as much as 16.5 ounces, or may be as little as 14 ounces. Recording the weight of the drained tofu is essential.

Optionally, the embodiment comprises colorings for example, but not limited to, saffron threads, beet juice, squid ink, or cooked and drained spinach. Optionally, the embodiment comprises flavoring agents. Typically, the embodiment may comprise finely chopped fresh or dried herbs, such as, but not limited to, rosemary, oregano, thyme, chives, chile powder, turmeric, ginger, raz el hanout, garlic, sage, and Herbs de Provence. Additional or alternative flavoring agents may be in the form of flavored oil, such as, but not limited to, white or black truffle oil, sesame chili oil, or the like. Salt may be Kosher salt, sea salt, iodized salt or the like.

Water is added to bring the weight of packaged tofu plus the seasoning and flavoring agents to 17 ounces.

In this embodiment, 15 ounces of wheat flour including such as semolina, all purpose flour, whole wheat flour, rye flour, or any combination thereof is added. Salt, preferably, 1 teaspoon kosher salt, is added. Other amounts of salt may be added also.

The total weight of tofu, flour, salt, and optional seasoning and flavoring agents is 32 ounces (15 ounces of flour plus 17 ounces of tofu, water, and seasoning and flavoring agents).

The procedure for making the pasta dough ball is very simple and is uniformly successful if the weights of the constituent ingredients have been determined as specified above. The ingredients may then be mixed using standard protocols known in the art such as for example but not limited to electric mixers. While the firm tofu may be first crudely mashed with a device such as a potato masher before mixing, equally acceptable mixing results when the block of firm tofu is added directly to the bowl of an electric mixer along with the other ingredients listed above. In this case, the mixing breaks up the tofu block so that it can blend with the other ingredients to form the pasta dough ball. Once the ingredients have been mixed, and a firm mass of dough is formed, the dough is rested for at least 30 minutes or up to a week in the refrigerator. The pasta dough may also be frozen by wrapping in plastic wrap and placing in a freezer bag. It may keep for months in the freezer at for example 0° C. to 5° C.

In a preferred embodiment, the dough may be shaped by any method traditionally used to shape fresh pasta. The inventive pasta may cook in gently boiling water in less than five minutes. Inventive lasagna does not need cooking prior to assembly and baking, but may be cooked if desired. The weight of the pasta may approximately double during cooking, as is the case of standard dried pasta and for the “fresh” egg based pastas found in supermarkets.

Lighter, softer pasta may be made by using 15 ounces all purpose flour or whole wheat flour and as much as 24 ounces of firm tofu. The greater the proportion of tofu relative to flour, the softer the pasta will be. However, the standard proportion of 15 ounces all purpose flour, or 15 ounces whole wheat flour, or any proportion of all purpose to whole wheat flour, totaling 15 ounces, when added to the 17 ounces of other ingredients including the firm tofu contained in a “14 ounce” package provides a surprisingly optimal ratio of firm tofu to flour for creating a fresh inventive pasta with the texture, taste, and appearance of fresh pasta of traditional composition. Surprisingly, additional ingredients, such as eggs or animal or vegetable fat, need not be, and are not added in order to make the flour and the tofu stick together to form the dough ball.

Increasing the proportion of tofu to flour creates lighter pastas that may appeal to some; the resulting product is even less caloric than standard inventive pasta.

Firmer pasta may be made by using 15 ounces all purpose flour or whole wheat flour and less than the 17 ounces of tofu and water specified in the standard recipe. The only reason to make pasta firmer than the standard recipe is to create a chewier firmer product; however, decreasing the proportion of tofu to flour will increase the calories and carbohydrates of the resulting pasta relative to those of the standard pasta recipe.

The resultant dough product may be dried and stored at room temperature.

In yet another embodiment, an inventive dough product may be used for example in the preparation of pizza dough and may be prepared according to the following methods.

In this embodiment, the tofu is again typically prepared by using a “14 ounce” package of firm tofu. The “14 ounce” package of firm tofu is drained. After draining, the weight of tofu is typically taken. The drained weight may be as much as about 16.5 ounces, or as little as about 14 ounces. Recording the weight of the drained tofu is essential. Water may be added to bring the weight of packaged tofu to about 16.5 ounces. 12 ounces of bread flour, or 12 ounces whole wheat flour, or any combination of bread flour, all purpose flour and whole wheat flour totaling 12 ounces is added. All purpose flour may be added alone or in combination with other types of flour. Thereafter, 1 teaspoon of sugar or alternative sweetener, such as sucralose or aspartame, 1 teaspoon of salt, and 3 teaspoons of yeast may be added to the mixture. The total weight of the mixture disclosed in this embodiment is about 29.5 ounces. Weight of the mixture may be increased or decreased as long as the proportions are kept relatively constant.

The ingredients are then mixed using standard methods. The inventive range of ratios of tofu by weight to flour by weight consistently results in the formation of a dough ball with. Once a firm ball of dough is formed, the dough is allowed to rise by standard methods. For best flavor, the dough is refrigerated overnight. The inventive pizza dough may be frozen and kept for months. The inventive combination of tofu, flour, and yeast specified above result in a product that is easily rolled into a pizza crust. This preferred embodiment of inventive pizza dough contains approximately 749 calories, 40.8 g protein and 154 g carbohydrates per pound, and no cholesterol or added fat. It contains approximately 30% fewer calories and carbohydrates than conventional pizza dough, which typically contains added oil.

Greater proportions of tofu yield a pizza dough that is softer and therefore harder to handle. Higher proportions of flour provide no advantage in taste, texture, and increase the calories and carbohydrates of the pizza dough per unit weight. However, about 10-15% variations in the relative amounts of tofu and flour are not critical. Larger amounts of pizza dough may be made by proportionately scaling up the quantity of each ingredient.

In certain embodiments, 15 ounces whole wheat flour may be substituted for bread flour. Up to 100% whole wheat flour may be used, or any proportion of whole wheat flour to bread flour totaling 15 ounces. Alternatively, any proportion of all purpose flour, or up to 50% rye flour, may be used. To make a pizza crust with corn meal flavor, 5 ounces corn meal may be substituted for up to 5 ounces bread flour.

In addition, in some embodiments, flavoring agents may be added to the dough, such as, but not limited to, red chilies, chopped fresh or dried herbs, flavored oils, or the like.

### EXAMPLE 6

### Methods of Making Waffle Batter

In another preferred embodiment, the methods disclosed herein are used in connection with preparing waffles. The following discussion pertains to making about 30.8 ounces waffle batter. More or less batter may be made using the proportions of ingredients disclosed herein.

In this embodiment, the tofu is prepared by using a “14 ounce” package of firm tofu. Alternatively, any other size package of tofu may be used as long as the weight of the tofu is taken. The “14 ounce” package of firm tofu is drained. After draining, the weight of tofu is taken. The drained weight may be as little as much as 16.5 ounces, or as little as 14 ounces. Recording the weight of the drained tofu is useful. Then 2.5-3.75 ounces, or ½-¾ cup, all purpose flour or whole wheat flour, or any proportions of each of these two flours are added to the mixture. In one aspect of the preferred embodiment, 2 ounces (¼ cup) egg substitute, 1 teaspoon Kosher salt, 2 teaspoons baking powder, 1 tablespoon vanilla extract, and 10 ounces water (1¼ cup) is added to the mixture. Sweetening agents may be added if desired but are not necessary.

The ingredients are then made into a batter by blending. The batter may be heterogeneous or homogeneous. The batter is typically used to make food products. Generally, the batter is used to make waffles by standard methods. Additions sometimes added to waffle batter such as but not limited to blueberries or chocolate chips, may be added to the batter before cooking in a waffle iron.

In alternate embodiments, the portion of flour to tofu may be doubled to produce waffles that are not as light and fluffy.

### EXAMPLE 7

In yet another preferred embodiment, the methods disclosed herein are used in connection with preparing ground meat and ground seafood products such as, but not limited to, sausages, hamburgers, seafood sausage or the like. The following discussion pertains to methods of making these products.

The process of making sausages and hamburgers involves combining ground firm tofu with ground meat or fish to create inventive sausages and hamburgers. The tofu acts to bind the ingredients together, and, surprisingly, no other typically used binding agents, such as added animal fat, eggs, cream, or added protein extracts are needed. In preferred embodiments, lean ground meat is combined with ground tofu. Tofu ground in a meat grinder substitutes for ground fat in making sausages with chicken, pork, veal, beef, or lamb. Tofu ground in a meat grinder substitutes for the egg and cream usually employed to bind the ingredients of sausages made with meat, fish and/or shellfish. One type of meat or combinations of different types of meat may be combined with the tofu. Tofu not only helps bind the ground meat product ingredients, its inclusion is a key factor in decreasing the calorie and animal fat content of the resulting ground meat product per unit weight.

In a preferred embodiment of the invention, tofu is used to bind the meat together. The tofu is preferably derived from packaged tofu that is ground before combining with the meat. Binding may be accomplished by mixing the ingredients in an electric mixer at a low speed for two or more minutes, or by hand for 3-5 minutes for example. In one aspect of this preferred embodiment, the meat or seafood product comprises of about 20%, preferably about 20-30%, and highly preferably about 33% tofu by weight. 33% tofu provides a good balance between retaining the natural taste of the meats, fish, or shellfish, and reducing the calories, fats, and cholesterol content per unit weight. As the proportion of tofu is increased up to 50%, the products retain shape, but progressively taste less like meat or fish.

The invention described and claimed herein is not to be limited in scope by the specific preferred embodiments herein disclosed, since these embodiments are intended as illustrations of several aspects of the invention. Any equivalent embodiments are intended to be within the scope of this invention.

What is claimed is:

1. A dough ball comprising of greater than from about 35% to less than about 65% by weight firm tofu and greater than about 30% to the less than about 65% by weight flour.

2. The dough ball of claim 1, wherein the dough ball comprises greater than about 40% to less than about 62% by weight firm tofu, and greater than about 35% to less than about 60% by weight flour.

3. The dough ball of claim 2, wherein the dough ball comprises greater than about 40% to less about 48% by weight firm tofu, and greater than about 50% to less than about 60% by weight flour.

4. The dough ball of claim 1, wherein the dough ball does not comprise shortening.

5. The dough ball of claim 1, wherein the dough ball does not comprise egg products.

6. A dough ball, wherein the dough ball comprises greater than about 30% to less than about 66% by weight firm tofu, and greater than about 30% to less than about 61% by weight flour.

7. The dough ball of claim 6, wherein the dough ball comprises greater than about 35% to less than about 61% by weight firm tofu, and greater than about 35% to less than about 54% by weight flour.

8. The dough ball of claim 7, wherein the dough ball comprises greater than about 49% to less than about 61%, by weight firm tofu, and greater than about 37% to less than about 47% by weight flour.

9. The dough ball of claim 6, further comprising of from about 0.01% to about 3.0% by weight sweetening agent.

10. The dough ball of claim 6, wherein the dough ball does not comprise shortening.

11. The dough ball of claim 6, wherein the dough ball does not comprise milk products.

12. A waffle batter comprising of from greater than about 35% to less than about 65% by weight tofu and from greater than about 5% to less than about 25% by weight flour.

13. The waffle product of claim 12, wherein the waffle product comprises of from greater than about 40% to less than about 60% tofu by weight, and from greater than about 6% to less than about 18% flour by weight.

14. The waffle product of claim 13, wherein the waffle product comprises of from greater than about 43% to less than about 57% tofu by weight, and from greater than about 8% to less than about 13% flour by weight.

15. The waffle product of claim 12, further comprising from about 20% to about 40% water by weight.

16. The dough ball of claim 6, further comprising a leavening agent.

17. A meat or fish product comprising meat and tofu, wherein the tofu is firm tofu.

18. The meat or fish product of claim 17, wherein the product comprises at least about 20% tofu by weight.

19. The meat or fish product of claim 18, wherein the product comprises about 33% tofu by weight.

20. A process of making a meat or fish product comprising:
grinding firm tofu in a meat grinder;
binding firm tofu with meat or fish; and
wherein the firm tofu is at least 20% by weight of the meat or fish product.

21. The process of claim 20, wherein said binding is accomplished by use of a mixer.

22. A method of making a dough product comprising:
providing firm tofu;
draining the firm tofu;
weighing the firm tofu;
mashing the firm tofu;
adding flour; and
wherein the dough product comprises from about 40% to about 55% by weight tofu, and from about 45% to about 60% by weight flour.

23. A method of making a waffle batter comprising:
providing firm tofu;
draining the firm tofu;
weighing the firm tofu;
adding flour;
adding water;
using a blender to mix; and
wherein the waffle product comprises of from about greater than about 43% to less than about 57% by weight tofu and from about greater than 8% to less than about 13% by weight flour.

24. A method of making a dough product comprising:
providing firm tofu;
draining the firm tofu;
weighing the firm tofu;
mashing the firm tofu;
adding flour; and
wherein the dough product comprises from about 49% to about 61% by weight firm tofu, and from about 37% to about 47% by weight flour.

25. A food product made from the dough ball of claim 1.

26. A food product made from the waffle batter of claim 12.

27. A food product made from the process of claim 22.

28. A food product made from the process of claim 23.

29. A food product made from the process of claim 24.

30. The dough ball of claim 6, wherein the flour comprises from greater than 0% to about 50% by weight masa harina.
